(19) United States
(12) Patent Application Publication
(10) Pub. No.: US 2003/0222931 A1
(43) Pub. Date: Dec. 4, 2003

(54) Method of and apparatus for managing nozzle of ink-jet printer

(75) Inventors: Dae-Hyeok Im, Gyeonggi-do (KR); Young-Bok Ju, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/347,691

(22) Filed: Jan. 22, 2003

(30) Foreign Application Priority Data
Jun. 4, 2002 (KR) 2002-31292

(51) Int. Cl. B41J 29/38

(52) U.S. Cl. 347/14

(57) ABSTRACT

A method of and an apparatus for managing a nozzle of an ink-jet printer include determining whether an operation of printing a document is requested, counting slices of print data if it determined that the operation of printing the document is requested, determining whether a counting result of counting the slices is larger than a first predetermined value and performing the counting of the slices if it is determined that the counting result is not larger than the first predetermined value, managing the nozzle if it is determined that the counting result is larger than the first predetermined value, and determining whether an operation of printing the document is terminated, and performing the counting of the slices if it is determined that the operation of printing the document is not terminated. The nozzle can be effectively managed by considering an amount of ink that is actually ejected through the nozzle and a print time, thereby improving a printing quality of the printed document.

### CROSS-REFERENCE TO RELATED APPLICATIONS

This application claims the benefit of Korean Patent Application No. 2002-31292, filed Jun. 4, 2002, in the Korean Intellectual Property Office, the disclosure of which is incorporated herein by reference.

### BACKGROUND OF THE INVENTION

1. Field of the Invention

The present invention relates to an ink-jet printer, and more particularly, to a method of and an apparatus for managing a nozzle in an ink-jet printer.

2. Description of the Related Art

A head in an ink-jet printer has a plurality of nozzles. Here, each nozzle is driven in response to a nozzle drive signal, and thus ink is ejected through the nozzle. In this case, a printing quality of the ink-jet printer depends on whether each nozzle operates normally. For example, when the nozzle is clogged because the nozzle has not been used for a long time, or the when the ink is continuously ejected through the nozzle regardless of a special management taken by the ink-jet printer, and thus the ink of different colors are mixed together. As a result, the printing quality is lowered. To prevent the printing quality from being lowered, the ink-jet printer must perform operations of managing the nozzle before or during printing.

Hereinafter, a conventional method for managing a nozzle of an ink-jet printer will be described.

First, when power is applied to the ink-jet printer, a new head is installed in the ink-jet printer, or a predetermined amount of time has passed from a previous printing time when the ink-jet printer performed any operation, managing operations of wiping a nozzle once and ejecting ink through the nozzle an appropriate number of times is repeated twice, and then, the nozzle can be capped. In addition, when the managing operations of the nozzle are instructed by a user, for example, when it is determined by the user that a printing quality is not good enough or that the nozzle needs to be managed, the managing operations of wiping a nozzle once and ejecting ink through the nozzle an appropriate number of times can be repeated three times. Further, the managing operations of wiping the nozzle once and ejecting ink through the nozzle an appropriate number of times can be performed once before each page of a document is printed. Furthermore, the managing operations of wiping a nozzle once and ejecting ink through the nozzle an appropriate number of times can be performed after a predetermined number of lines are printed during printing the document.

In the above-mentioned conventional method of managing the nozzle of the ink-jet printer, the nozzle is managed only depending on the number of lines printed, regardless how much ink is ejected while the document is printed. Hence, in the conventional method of managing the nozzle of the ink-jet printer, the managing operations of managing the nozzle are not performed when the nozzle really needs to be managed, and the managing operations of managing the nozzle are unnecessarily performed when the nozzle does not need to be managed. Thus, the conventional method of managing the nozzle of the ink-jet printer cannot provide a uniform printing quality.

### SUMMARY OF THE INVENTION

To solve the above and the other problems, it is an aspect of the present invention to provide a method of managing a nozzle of an ink-jet printer in response to an amount of ink actually ejected and an ejection time during which the ink is ejected through the nozzle.

It is another aspect of the present invention to provide an apparatus for managing a nozzle of an ink-jet printer in response to an amount of ink actually ejected and an ejection time during which the ink is ejected through the nozzle.

Additional aspects and advantages of the invention will be set forth in part in the description which follows and, in part, will be obvious from the description, or may be learned by practice of the invention.

Accordingly, to achieve the above and/or other aspects, there is provided a method of managing a nozzle of an ink-jet printer. The method comprises determining whether an operation of printing a document is requested, counting slices of print data if it is determined that the operation of printing the document is requested, determining whether a counting result of counting the slices is larger than a first predetermined value, performing the counting of the slices if it is determined that the counting result is not larger than the first predetermined value, managing the nozzle if it is determined that the counting result is larger than the first predetermined value, determining whether the operation of printing the document is terminated, and performing the counting of the slices if it is determined that the operation of printing the document is not terminated.

In order to achieve the above and/or other aspects, there is provided an apparatus for managing a nozzle of an ink-jet printer. The apparatus includes a print request checking unit which checks whether an operation of printing a document is requested and outputs a checking result of checking the operation of printing document as a first control signal when the operation of printing the document is requested, a counter which counts slices of print data in response to the first control signal and outputs a counting result, a comparator which compares the counting result received from the counter with a first predetermined value and outputs a result of the comparison as a second control signal, a nozzle managing unit which manages the nozzle in response to the second control signal, and a print termination checking unit which checks whether the operation of printing the document is terminated and outputs a checking result as a third control signal. The counter counts the slices of the print data in response to the first control signal, the second control signal, and the third control signal and outputs the counting result.

### BRIEF DESCRIPTION OF THE DRAWINGS

The above and/or the other aspects and advantages of the present invention will become more apparent and more readily appreciated from the following description of preferred embodiments, taken in conjunction with the accompanying drawings of which:

FIG. 1 is a flowchart illustrating a method of managing a nozzle of an ink-jet printer according to an embodiment of the present invention;

FIG. 2 is a flowchart illustrating a method of managing a nozzle of an ink-jet printer according to another embodiment of the present invention;

FIG. 3 is a flowchart illustrating a method of managing a nozzle of an ink-jet printer according to another embodiment of the present invention;

FIG. 4 is a block diagram illustrating an apparatus for managing a nozzle of an ink-jet printer using the methods shown in FIG. 1;

FIG. 5 is a block diagram illustrating an apparatus for managing a nozzle of an ink-jet printer using the method shown in FIGS. 1 and 2; and

FIG. 6 is a block diagram illustrating an apparatus for managing a nozzle of an ink-jet printer using the method shown in FIGS. 1 and 3.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described in order to explain the present invention by referring to the figures.

The present invention will be described more fully hereinafter with reference to the accompanying drawings in which preferred embodiments of the invention are shown.

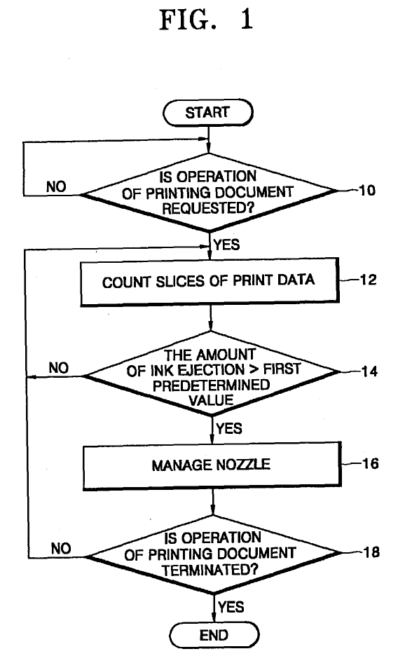

FIG. 1 is a flowchart illustrating a method of managing a nozzle of an ink-jet printer according to an embodiment of the present invention. The flowchart shown in FIG. 1 comprises obtaining an amount of ink ejection when a document needs to be printed in operations 10 and 12 and maintaining a nozzle according to a result of comparing the amount of the ink ejection with a first predetermined value in operations 14 through 18.

In operation 10, it is determined whether the document needs to be printed. If it is determined that the document needs to be printed, slices of print data are counted in operation 12. Here, the print data includes a number of slices, each slice has several bits, and each bit is used to enable ink to be ejected through each nozzle. For example, the print data may be generated by a personal computer (PC) (not shown) and transmitted to the ink-jet printer.

According to the embodiment of the present invention, in operation 14 after operation 12, it is determined whether the amount of the ink ejection, that is, a counting result of counting of the slices of the print data, is larger than the first predetermined value. Here, the first predetermined value is empirically obtained. If it is determined that the counting result, that is, the amount of the ink ejection, is not larger than the first predetermined value, the counting of the slices of the print data continues. However, if it is determined that the counting result, that is, the amount of the ink ejection, is larger than the first predetermined value, in operation 16, the nozzle is managed. Here, if it is determined that the counting result, that is, the amount of the ink ejection, is larger than the first predetermined value, at least one of an operation of wiping the nozzle, an operation of ejecting ink through the nozzle, and an operation of capping the nozzle can be performed. For example, if it is determined that the counting result, that is, the amount of the ink ejection, is larger than the first predetermined value, operations of wiping the nozzle once and ejecting ink through the nozzle x times (where x is a predetermined number) can be performed. In this way, in the method of managing the nozzle of the ink-jet printer according to the present invention, only if the counting result, that is, the amount of the ink ejection, is larger than the first predetermined value, the nozzle is managed regardless of whether an initial part or a middle part of the document is printed.

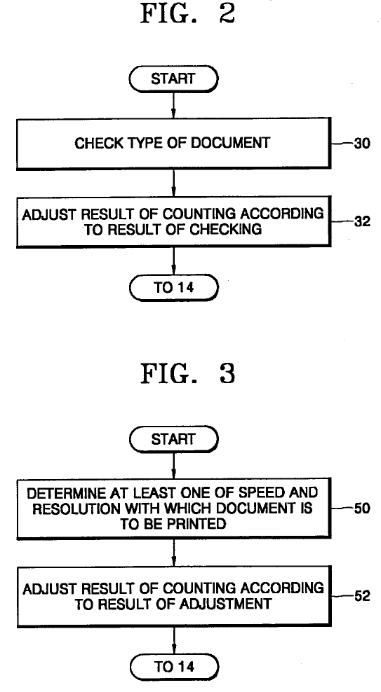

FIG. 2 is a flowchart illustrating an operation of the method of managing the nozzle of the ink-jet printer according to another embodiment of the present invention. The flowchart shown in FIG. 2 comprises adjusting the counting result of the counting the slices of the print data according to a type of the document in operation 30 and 32.

The method of managing the nozzle of the ink-jet printer shown in FIG. 1 may further include operations 30 and 32 shown in FIG. 2. In this case, in operation 30 performed after operation 12, the type of the document is checked. That is, it is checked whether the document to be printed is a text or graphics. In operation 32 performed after operation 30, the counting result is adjusted according to the checked type of the document, a result of an adjustment of the counting result is determined as the amount of the ink ejection, and then, operation 14 is performed. Thus, in operation 14, it is determined whether the result of the adjustment of operation 32 corresponding to the amount of the ink ejection is larger than the first predetermined value.

For example, when the type of the document is the text, the counting result is multiplied by a second predetermined value, and a result of the multiplication is determined as the amount of the ink ejection. In addition, when the type of the document is the graphics, the counting result is multiplied by a third predetermined value, and the result of the multiplication is determined as the amount of the ink ejection. In this case, the third predetermined value is set to be larger than the second predetermined value. For example, the second predetermined value may be set to 10, 20 or 30, and the third predetermined value may be set to 40 or 50. However, it is understood that the invention is not limited thereto.

FIG. 3 is a flowchart illustrating another operation of the method of managing the nozzle of the ink-jet printer according to another embodiment of the present invention. The flowchart shown in FIG. 3 comprises adjusting the accounting result according to printing conditions in operations 50 and 52.

The method of managing the nozzle of the ink-jet printer shown in FIG. 1 may further include operations 50 and 52 of FIG. 3. In this case, in operation 50 performed after operation 12, the printing conditions of the document, that is, at least one of a speed and a resolution with which the document is printed, is determined. In operation 52, the counting result is adjusted according to a result of a determination of the printing conditions in operation 50, the result of an adjustment of the counting result is determined as the amount of the ink ejection, and then, operation 14 is performed. Thus, in operation 14, it is determined whether the result of the adjustment of operation 52 corresponding to the amount of the ink ejection is larger than the first predetermined value.

For example, when a user wants to print the document with a low resolution at a high speed, the counting result is multiplied by a fourth predetermined value corresponding to the low resolution and the high speed, and the result of the multiplication is determined as the amount of the ink ejection. In addition, when the user wants to print a document with a high resolution at a low speed, the counting result is multiplied by a fifth predetermined value corresponding to the high resolution and the low speed, and the result of the multiplication is determined as the amount of the ink ejection. In this case, the fifth predetermined value is set to be larger than the fourth predetermined value. For example, when the document is the text, the fourth predetermined value may be set to 10, and the fifth predetermined value may be set to 30. When the document is the graphics, the fourth predetermined value may be set to 40, and the fifth predetermined value may be set to 50. However, it is understood that the invention is not limited thereto.

Meanwhile, in operation 18 performed after operation 16, it is determined whether the operation of printing the document is terminated. If it is determined that the operation of printing the document is not terminated, operation 12 is performed. However, if it is determined that the operation of printing the document is terminated, the method of managing the nozzle of the inkjet printer shown in FIG. 1 is terminated. Thus, the counting result is reset. In this case, the operation of printing the document is performed while operations 12, 14, and 16 shown in FIG. 1 are performed.

Hereinafter, a structure and an operation of an apparatus for managing the nozzle of the ink-jet printer performing the above-mentioned respective methods shown in FIGS. 1 through 3, will be described with reference to the accompanying drawings.

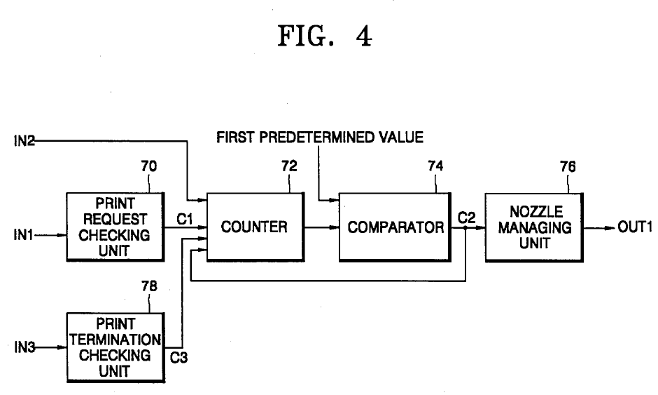

FIG. 4 is a block diagram illustrating the apparatus for managing the nozzle of the inkjet printer performing the method shown in FIGS. 1 through 3.

Referring to FIG. 4, the apparatus includes a print request checking unit 70, a counter 72, a comparator 74, a nozzle managing unit 76, and a print termination checking unit 78.

In order to perform operation 10 shown in FIG. 1, the print request checking unit 70 checks whether the operation of printing the document is requested and outputs the checking result of checking the printing of the document as a first control signal C1 to the counter 72. For example, a personal computer (PC) may generate a print request signal used to request the printing of the document. In this case, the print request checking unit 70 can analyze the print request signal that is received from the PC through an input terminal IN1 and can check whether the operation of printing the document is requested.

In order to perform operation 12, the counter 72 counts the slices of the print data that is inputted to an input terminal IN2, in response to the first control signal C1 that is received from the print request checking unit 70, and the counter 72 outputs the counting result of the counting of the slices to the comparator 74. For example, if it is recognized through the first control signal C1, which is received from the print request checking unit 70, that the operation of printing the document is requested, the counter 72 counts the slices of the print data inputted to the input terminal IN2 and outputs the counting result to the comparator 74.

In order to perform operation 14, the comparator 74 compares the counting result, that is, the amount of the ink ejection, which is received from the counter 72, with the first predetermined value and outputs the result of the comparison as a second control signal C2 to the nozzle managing unit 76 and the counter 72, respectively. In this case, if it is recognized through the second control signal C2, which is received from the comparator 74, that the amount of the ink ejection is not larger than the first predetermined value, the counter 72 continuously counts the slices of the print data inputted to the input terminal IN2 and outputs the counting result to the comparator 74.

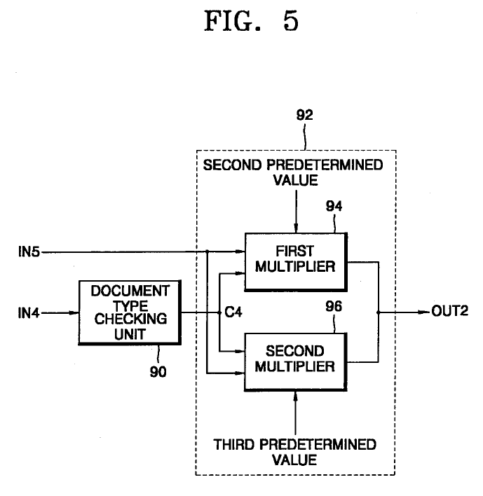

FIG. 5 is a block diagram illustrating another apparatus performing the respective methods shown in FIGS. 1 and 2. Referring to FIG. 5, the apparatus for managing the nozzle of the ink-jet printer includes a document type checking unit 90 and a first ink ejection amount adjusting unit 92.

The apparatus shown in FIG. 4 may further include the document type checking unit 90 and the first ink ejection amount adjusting unit 92. In this case, in order to perform operation 30, the document type checking unit 90 shown in FIG. 5 checks the type of the document and outputs the checking result of the checking of the type of the document as a fourth control signal C4 to the first ink ejection amount adjusting unit 92. For example, the PC may generate a document type discrimination signal representing the type of the document. In this case, the document type checking unit 90 can analyze the document type discrimination signal that is received from the PC through an input terminal IN4, and can check the type of the document to be printed, that is, whether the document to be printed is the text or the graphics, through a result of an analysis of the document type discrimination signal.

In order to perform operation 32, the first ink ejection amount adjusting unit 92 adjusts the counting result that is inputted to an input terminal IN5 from the counter 72, in response to the fourth control signal C4 that is received from the document type checking unit 90, and outputs the result of adjustment as the amount of the ink ejection to the comparator 74 shown in FIG. 4 through an output terminal OUT2. In this case, the comparator 74 compares the amount of the ink ejection that is received from the first ink ejection amount adjusting unit 92, with the first predetermined value and outputs the result of the comparison as the second control signal C2. For this purpose, the first ink ejection amount adjusting unit 92 may be implemented with first and second multipliers 94 and 96. Here, the first multiplier 94 multiplies the counting result inputted to the input terminal IN5, by the second predetermined value in response to the fourth control signal C4 that is received from the document type checking unit 90, and outputs the result of the multiplication as the amount of the ink ejection through the output terminal OUT2.

In addition, the second multiplier 96 multiplies the counting result by the third predetermined value in response to the fourth control signal C4 that is received from the document type checking unit 90, and outputs the result of the multiplication as the amount of the ink ejection through the output terminal OUT2. Here, only one of the first and second multipliers 94 and 96 operates in response to the fourth control signal C4. That is, if it is recognized through the fourth control signal C4 that the type of the document to be printed, is the text, the result of the multiplication in the first multiplier 94 is outputted as the amount of the ink ejection through the output terminal OUT2. Also, if it is recognized through the fourth control signal C4 that the type of the document to be printed is the graphics, the result of the multiplication in the second multiplier 96 is outputted as the amount of the ink ejection through the output terminal OUT2. The amount of the ink ejection corresponds to the second control signal to control the nozzle managing unit 76 to perform a combination of the capping operation, the wiping operation, and the ink-ejecting operation.

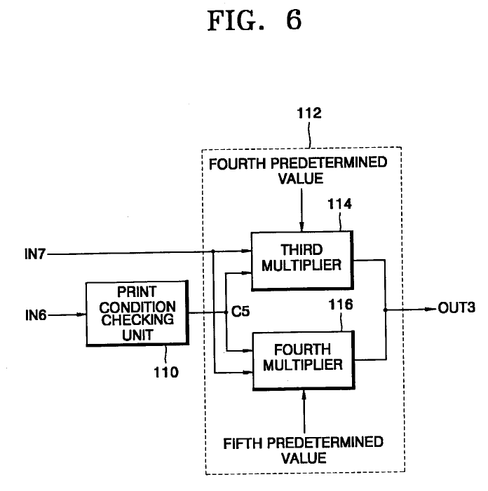

FIG. 6 is a block diagram illustrating another apparatus performing the method shown in FIGS. 1 and 3 according to another embodiment of the present invention. Referring to FIG. 6, the apparatus for managing the nozzle of the ink-jet printer includes a print condition checking unit 110 and a second ink ejection amount adjusting unit 112.

The apparatus for managing a nozzle of an ink-jet printer shown in FIG. 4 may further include the print condition checking unit 110 and the second ink ejection amount adjusting unit 112. In this case, in order to perform operation 50, the print condition checking unit 110 shown in FIG. 6 determines the printing conditions, that is, at least one of the speed and the resolution with which the document is to be printed, and outputs the result of the determination as the fifth control signal C5 to the second ink ejection amount adjusting unit 112. For example, the PC may generate a printing condition discrimination signal representing the printing conditions. In this case, the print condition checking unit 110 can analyze the printing condition discrimination signal that is received from the PC through an input terminal IN6, and can check through the result of the analysis of the printing conditions with which the document is to be printed.

In order to perform operation 52, the second ink ejection adjusting unit 112 adjusts the counting result that is inputted to an input terminal IN7 from the counter 72 shown in FIG. 4, in response to the fifth control signal C5 that is received from the print condition checking unit 110, and outputs the result of the adjustment of the counting result as the amount of the ink ejection to the comparator 74 through an output terminal OUT3. In this case, the comparator 74 compares the amount of the ink ejection that is received from the second ink ejection amount adjusting unit 112, with the first predetermined value, and outputs the result of the comparison as the second control signal C2. For this purpose, the second ink ejection amount adjusting unit 92 may be implemented with third and fourth multipliers 114 and 116. Here, the third multiplier 114 multiplies the counting result that is inputted from the counter 72 through an input terminal IN7, by a fourth predetermined value in response to the fifth control signal C5 that is received from the print condition checking unit 110, and outputs the result of the multiplication as the amount of the ink ejection through an output terminal OUT3 to the comparator 74.

In addition, the fourth multiplier 116 multiplies the counting result that is inputted through the input terminal IN7 from the counter 72, by a fifth predetermined value in response to the fifth control signal C5 that is received from the print condition checking unit 110, and outputs to the comparator 74 the result of the multiplication as the amount of the ink ejection through the output terminal OUT3. Here, only one of the third and fourth multipliers 114 and 116 operates in response to the fifth control signal C5. For example, if it is recognized through the fifth control signal C5 that the document is printed at the high speed with the low resolution, the result of the multiplication in the third multiplier 114 is outputted as the amount of the ink ejection through the output terminal OUT3. Also, if it is recognized through the fifth control signal C5 that the document is printed at the low speed and with the high resolution, the result of the multiplication in the fourth multiplier 116 is outputted as the amount of the ink ejection through the output terminal OUT3.

Meanwhile, in order to perform operation 16, the nozzle managing unit 76 manages the nozzle in response to the second control signal C2 that is received from the comparator 74. For example, the nozzle managing unit 76 manages the nozzle if it is recognized through the second control signal C2, which is received form the comparator 74, that the amount of the ink ejection is larger than the first predetermined value. For example, the nozzle managing unit 76 can output at least one of a wiping drive signal, a spitting drive signal, and a capping drive signal simultaneously or sequentially through the output terminal OUT1. In this case, a wiping unit (not shown) can perform the operation of wiping the nozzle in response to the wiping drive signal, a spitting unit (not shown) can eject ink through the nozzle in response to the spitting drive signal, and a capping unit (not shown) can cap the nozzle in response to the capping drive signal.

Meanwhile, in order to perform operation 18, the print termination checking unit 78 checks whether the operation of printing the document is terminated, and outputs the checking result as the third control signal C3 to the counter 72. For example, the PC may generate a print termination signal representing an end of the operation of printing the document. In this case, the print termination checking unit 78 can analyze the print termination signal that is received form the PC through the input terminal IN3, and can check the termination of the operation of printing the document through the result of the analysis. In this case, if it is recognized through the third control signal C3, which is received from the print termination checking unit 78, that the operation of printing the document is not terminated, the counter 72 continuously counts the slices of the print data that is inputted to the input terminal IN2, and outputs the counting result to the comparator 74.

As described above, the method of and apparatus for managing a nozzle of an ink-jet printer according to the present invention can effectively manage the nozzle in response to the amount of ink that is actually ejected, and a print time, unlike the related art which periodically manages the nozzle at a predetermined time interval while the document is printed. That is, the method of and apparatus for managing the nozzle of the ink-jet printer according to the present invention can effectively manage the nozzle without performing operations of managing the nozzle when the amount of the ink ejection is small, and by performing the operations of managing the nozzle when the amount of the ink ejection is large even though several lines are printed, thereby improving a printing quality.

While this invention has been particularly shown and described with reference to preferred embodiments thereof, it will be understood by those skilled in the art that various changes in form and details may be made therein without departing from the spirit and scope of the invention as defined by the appended claims and equivalents thereof.

What is claimed is:

1. A method of managing a nozzle of an ink-jet printer, the method comprising:
determining whether an operation of printing a document is requested;
counting slices of print data in response to determining that the operation of printing the document is requested;
determining whether a counting result of the counting of the slices of the print data is larger than a first value and performing the counting of the slices of the print data in response to determining that the counting result is not larger than the first value;
managing the nozzle in response to determining that the counting result is larger than the first value; and
determining whether the operation of printing the document is terminated, and performing the counting of the slices in response to determining that the operation of printing the document is not terminated.

2. The method of claim 1, further comprising:
checking a type of the document; and
adjusting the counting result according to the type of the checked document and generating the adjusted counting result as the counting result.

3. The method of claim 2, wherein the adjusting of the counting result comprises:
multiplying the counting result by a second value when the type of the document is a text, and generating the multiplied counting result as the counting result; and
multiplying the counting result by a third value, which is larger than the second value, when the type of the document is graphics, and generating the multiplied counting result as the counting result.

4. The method of claim 1, further comprising:
determining at least one of speed and resolution with which the document is to be printed; and
adjusting the counting result according to the result of the determination and proceeding generating the adjusted counting result as the counting result.

5. The method of claim 1, wherein the managing of the nozzle comprises:
performing at least one of an operation of wiping the nozzle, an operation of ejecting ink through the nozzle, and an operation of capping the nozzle in response to determining that the counting result is larger than the first value.

6. An apparatus for managing a nozzle of an ink-jet printer, the apparatus comprising:
a print request checking unit which checks whether an operation of printing a document is requested, and outputs a checking result of the checking of the operation of printing a document as a first control signal;
a counter which counts slices of print data in response to the first control signal and outputs a counting result of counting the number of the slices of the print data;
a comparator which compares the counting result received from the counter with a first value and outputs a result of the comparison as a second control signal;
a nozzle managing unit which manages the nozzle in response to the second control signal; and
a print termination checking unit which checks whether the operation of printing the document is terminated, and outputs the checking result as a third control signal to control the counter to terminate the counting of the slices.

7. The apparatus of claim 6, further comprising:
a document type checking unit which checks a type of the document and
outputs a checking result of checking the type of the document as a fourth control signal; and
a first ink ejection amount adjusting unit which adjusts the counting result received from the counter, in response to the fourth control signal and outputs a result of the adjustment of the counting result as an amount of ink ejection to the comparator;
wherein the comparator compares the amount of the ink ejection with the first value to output the second control signal.

8. The apparatus of claim 7, wherein the first ink ejection amount adjusting unit comprises:
a first multiplier which multiplies the counting result by a second value in response to a first state of the fourth control signal and outputs a result of the first multiplication as the amount of the ink ejection; and
a second multiplier which multiplies the result of counting by a third value in response to a second state of the fourth control signal and outputs a result of the second multiplication as the amount of the ink ejection to the comparator.

9. The apparatus of claim 6, further comprising:
a print condition checking unit which determines one of a speed and a resolution with which the document is to be printed, and outputs a result of the determination of the one of the speed and the resolution as a fifth control signal; and
a second ink ejection amount adjusting unit which adjusts the counting result received from the counter, in response to the fifth control signal and outputs a result of an adjustment of the counting result as the first control signal to the comparator;
wherein the comparator compares the amount of the ink ejection with the first predetermined value to output the second control signal.

10. The apparatus of claim 9, wherein the second ink ejection amount adjusting unit comprises:
a first multiplier which multiplies the result of counting by a fourth predetermined value in response to a first state of the fifth control signal and outputs a result of the first multiplication as the amount of the ink ejection; and
a second multiplier which multiplies the result of counting by a fifth predetermined value in response to a second state of the fifth control signal and outputs a result of the second multiplication as the amount of the ink ejection to the comparator.

11. An apparatus for managing a nozzle of an ink-jet printer printing a document, comprising:
a counter counting the number of slices of print data corresponding to the document, and generating a counting result; and
a nozzle managing unit managing the nozzle in accordance with the counting result.

12. The apparatus of claim 11, further comprising:
a document type checking unit checking a type of the document and generating a checking result, wherein the nozzle managing unit manages the nozzle in response to the checking result.

13. The apparatus of claim 12, further comprising:
an ink ejection amount adjusting unit adjusting the counting result to generate the adjusted counting result, wherein the nozzle managing unit manages the nozzle in response to the adjusted counting result.

14. The apparatus of claim 13, further comprising:
a comparator compares the adjusted counting result with the first reference value to generate a result of the comparison, wherein the nozzle managing unit manages the nozzle in response to the result of the comparison.

15. The apparatus of claim 11, further comprising:
a print condition checking unit checking a print condition of the document to be printed using the print data, and generating a checking result, wherein the nozzle managing unit manages the nozzle in response to the checking result.

16. The apparatus of claim 15, further comprising:
an ink ejection amount adjusting unit adjusting the counting result to generate the adjusted counting result, wherein the nozzle managing unit manages the nozzle in response to the adjusted counting result.

17. The apparatus of claim 11, further comprising:
a print termination checking unit checking whether an operation of printing the document is terminated, and outputting a checking result of checking the operation of the printing of the document as a terminating control signal to control the counter to terminate the counting of the slices.

18. An apparatus for managing a nozzle of an ink-jet printer printing a document, comprising:
a counter calculating an amount of ink ejection to be consumed during printing the document; and
a nozzle managing unit managing the nozzle in accordance with the calculated amount of the ink ejection.

19. A method of managing a nozzle of an ink-jet printer, comprising:
counting the number of slices of print data corresponding to a document to be printed, and generating a counting result; and
performing at least one of a capping operation, a wiping operation, and an ink-ejecting operation in accordance with the counting result.

20. A method of managing a nozzle of an ink-jet printer printing a document, comprising:
calculating an amount of ink ejection to be consumed during printing the document; and
performing a combination of a capping operation, a wiping operation, and an ink-ejecting operation in accordance with the calculated amount of the ink ejection.
